(19) United States
(12) Patent Application Publication
(10) Pub. No.: US 2013/0325997 A1
(43) Pub. Date: Dec. 5, 2013

(54) REMOTE ASSET CONTROL SYSTEMS AND METHODS

(71) Applicants: James Higgins, North Kingstown, RI (US); Christopher D. Leidigh, Providence, RI (US); Jeffery Weiss, Lincoln, RI (US)

(72) Inventors: James Higgins, North Kingstown, RI (US); Christopher D. Leidigh, Providence, RI (US); Jeffery Weiss, Lincoln, RI (US)

(73) Assignee: ALEKTRONA CORPORATION, Providence, RI (US)

(21) Appl. No.: 13/988,207

(22) PCT Filed: Nov. 18, 2011
(86) PCT No.: PCT/US2011/061448

§ 371 Date: Aug. 26, 2013

Related U.S. Application Data
(60) Provisional application No. 61/415,484, filed on Nov. 19, 2010.
(60) Provisional application No. 61/418,941, filed on Dec. 2, 2010.

(51) Int. Cl. H04L 29/08

(52) U.S. Cl. CPC H04L 67/125
USPC 709/208

(57) ABSTRACT

A remote asset control system for optimized asset performance under a variety of circumstances, such as network communication path failures, software maintenance, software faults, hardware faults, hardware maintenance, computer system maintenance, computer system failure, undetected data errors, configuration errors, human error, power outages, malicious network attacks, and the like, having a means to create, modify, and delete asset policies, an object oriented asset policy inheritance scheme that generates composite asset policies, an asset policy transference and caching scheme, condition driven asset policy enforcement, permission-based asset policy mechanism for throttling energy or water consumption, asset replacement simplification, query capability to enumerate actual asset deviance as compared to the currently enforced composite asset policy, real-time control asset policies, atomic activation and deactivation of asset policies, which are part of the policy inheritance hierarchy, ensuring composite policy integrity, and multi-tiered telemetry caching and transference.

### CROSS-REFERENCE TO RELATED APPLICATION

This application claims priority to U.S. Provisional Patent Application No. 61/415,484, filed Nov. 19, 2010 and U.S. Provisional Patent Application No. 61/418,941, filed Dec. 2, 2010, each of which is incorporated herein by reference.

### FIELD OF THE INVENTION

The present disclosure is in the technical field of asset management. More particularly, the present disclosure is in the technical field of remote asset control systems.

### BACKGROUND OF THE INVENTION

Conventional remote asset control systems, such as building management systems, energy management systems, utility demand response and load control systems, enterprise network management systems, and the like. Typically, the management systems require assets such as a thermostat, load controller, energy display, electric meter, gas meter, water meter, fuel storage tank, battery bank, energy storage system, PV solar panel, hot water heater, pool pump, exhaust fan, motorized window shade, network router, wireless access point, network switch, boiler, lighting system, computer, computer peripheral, television, VCR, video game system, audio system, washing machine, dishwasher, clothes dryer, un-interruptible power supply, wind turbine, power distribution unit, other home automation appliance, other energy consuming appliance, other co-generation equipment, and the like.

These assets are accessible, through a communication network path using a combination of the Internet, a public or private local area network, a public or private wide area network, and a public or private wireless area network. The communication network paths use a combination of differing physical, network, and application protocol technologies such as Ethernet, power line carrier, coaxial cable, RS-232, RS-485, Internet Protocol, Ethernet, Bluetooth, or fiber.

Control commands are requests made to an asset for the purposes of reading or writing asset attributes such as to affect the state of the asset or other connected device. For example, a read and write of the configuration of a thermostat's locally displayed temperature scale may occur along with a reading of: the current room temperature; the software version; the firmware version; the electricity consumption; and the configured set points. If a communication network path failure occurs between the remote asset control system and the asset, suboptimal asset performance occurs because time critical control commands cannot be processed. The failed processing leads to inefficiencies, financial and other types of losses, and/or degraded performance.

### SUMMARY OF THE INVENTION

For example, a large 11 kW oven used by a contract manufacturing facility for precisely reflowing solder on printed circuit boards is normally shutdown manually by employees on Friday evening and remains off until Monday morning. On one Friday evening the oven was not shutdown by employees. The manager, previously recognizing the potential that the employees may inadvertently leave the oven on, had subscribed to a monitoring service to detect and automate the shutdown of the oven in this case. However, a recent storm had damaged the cable modem providing Internet access to the contract manufacturer's facility. The monitoring service was using a conventional asset control system that relied on an Ethernet to Modbus/RS485 gateway at the oven location to communicate with the oven.

Due to the cable modem fault, the conventional remote asset system was unable to query the oven's status and turn off the oven via the Ethernet to Modbus/RS485 gateway and the contract manufacturer's electric bill incurred an additional 500 kWh of wasteful consumption above their normal usage. A remote asset control system as described within the present disclosure is able to detect that the oven was on and turn off the oven despite the cable modem fault by utilizing a schedule-based conditional composite asset policy enforced by a premise software-subsystem acting autonomously. The premise software-subsystem is able to query the oven for status and turn off the oven according to the schedule defined by the locally stored asset policy.

Further, as the number of communication network paths between the remote asset control system and the asset increases, the probability of communication network failures increases substantially. Therefore, suboptimal asset performance is likely to occur more frequently. Additionally, some forms of communication network paths are normally off. For example, cellular radio and satellite are only turned on at relatively infrequent intervals due to the high service costs. These communication network paths that are normally off are also problematic for remote asset control systems because such paths also prevent conventional asset control systems from issuing control commands to assets in a timely manner thus leading to suboptimal asset performance.

Commonly, utilities can forecast 24 hours in advance that supply will exceed demand. As part of a demand response program, the utility can command large numbers of AC load controllers to disconnect their loads, typically pool pumps, hot water heaters, and the like, for up to 4 hours. Conventional remote asset control systems typically wait until the load controllers need to be turned off before sending the control request. If the communication path to the load controller is down at that moment the load controller will not be turned off. The result is a problem for the utility since, if this communication failure were to happen in large scale, the utility may not be able to achieve the required load reduction, which in turn, may lead to rolling blackouts for their customers. However, a remote asset control system as described herein is able to, during the 24 hours leading up to the event, set a time-based conditional composite asset policy on a premise software-subsystem. The premise software-subsystem acts autonomously to enforce the policy and turn the load controllers off at the designated time enabling the utility to have a far greater confidence level that the required load reduction will be achieved.

The present disclosure also addresses the inability of conventional remote asset control systems to minimize gaps in asset telemetry. Asset telemetry gaps are interrupted portions of data collection. Asset telemetry, gathered by a remote asset control system, is typically processed by software applications that typically analyze individual asset performance such as: the ability to maintain room temperature; the state of an AC relay on a load controller during a utility demand response event; and detection of a manual thermostat set point override. Such information is used to analyze aggregate system performance. Typical performance parameters are a total amount of load shed and the number of customers opting out of a utility demand response event. By combining the telemetry of a plurality of assets, these parameters can be accurately determined.

Asset telemetry gaps reduce the ability of software applications to measure asset performance and aggregate system performance. The ability of software applications to further optimize asset performance and aggregate system performance is reduced as well. A conventional remote asset control system typically requires a working communication path to an asset at the time that telemetry needs to be collected otherwise the telemetry for that time is lost.

For example, a conventional remote asset control system communicating over the Internet to a customer premise having the ability to communicate to a ZigBee Smart Energy Profile 1.0 thermostat will not be able to collect thermostat telemetry, resulting in telemetry gaps, when the customer's internet service is not functioning. Further telemetry gaps can occur when the remote asset control system is offline for maintenance or when a maid unplugs the customer's broadband modem to make an outlet available for a vacuum, and the like. If a remote asset control system, as described in the present disclosure, is utilized, then the occurrence of telemetry gaps is greatly minimized because a premise software sub-system continues to collect telemetry from the thermostat regardless of the software sub-system's ability to communicate to the remote asset control system. In one embodiment, the remote asset control system in accordance with the subject technology is an embedded computer with an Ethernet connection to the Internet and a ZigBee Smart Energy Profile 1.0 interface, acting as an energy management system. When Internet connectivity between the remote asset control system and the software sub-system is restored, the historical telemetry collected during the communication outage is transferred to the remote asset control system.

The present disclosure is a remote asset control system for optimized asset performance having conditional policy-based asset control.

In one embodiment, the environment includes a remote asset control system that can create, modify, and delete asset policies within a grouping hierarchy that supports an asset policy inheritance scheme resulting in composite asset policies. The policy inheritance scheme makes it easier and more reliable for a software application to manage assets of similar ilk. The environment also has an asset policy transference and caching scheme, which moves policy enforcement to a software sub-system co-located with the asset thereby minimizing the potential for intermittent network communication to adversely affect asset performance. The software sub-system can conditionally enforce policies based upon internal, co-located, and remote events. And, where such events can be permission for an asset to operate at its highest energy or water consumption modes for short periods of time, but where the default, without permission, is to operate at lower levels of consumption.

Further, the environment can simplify asset replacement in the event of a hardware failure by allowing the software application to specify in advance the serial number, hardware address, and the like, of a replacement unit, thereby allowing the new unit to be immediately recognized and managed like the faulty asset which reduces the potential suboptimal performance. Still further, the environment can enumerate actual asset deviance as compared to the currently or previously enforced composite asset policies, allowing software applications to more quickly and easily identify faulty assets. Additionally, the environment allows real-time control asset policies that optimize communications when a human user expects low latency control and which operates in unison with the normal policy mechanisms. Furthermore, the environment allows atomic activation and deactivation of asset policies, which are part of the policy inheritance hierarchy, which ensures composite policy integrity at all times. The environment also has a multi-tiered telemetry caching and transference mechanism that maximizes the amount of telemetry available for software analytical operations which may enable further asset performance optimizations.

In another embodiment, the subject technology is directed to a system for facilitating a remote asset control system via a distributed computing network. The system includes a server in communication with premises via the distributed computing network. The server includes a memory storing an instruction set and data related to a plurality of asset policies, and a processor for running the instruction set, the processor being in communication with the memory and the distributed computing network, wherein the processor is operative to create the plurality of asset policies using an asset policy inheritance scheme that generates composite asset policies based upon a hierarchical group structure. The system also includes a plurality of the premises arranged in groups, each premise having at least one asset. Each asset includes a memory storing an instruction set and data related to a plurality of asset policies, and a processor for running the instruction set, the processor being in communication with the memory and the distributed computing network. The software sub-system processor is operative to receive and store the plurality of asset policies from the server, and control operation of the respective asset based upon the plurality of asset policies.

Each server processor may be further operative to store composite asset policies, and atomically activate and deactivate asset policies, which are part of the policy inheritance hierarchy, ensuring composite policy integrity. At least one of the plurality of asset policies may be a permission-based asset policy for throttling consumption by the respective asset. At least one of the plurality of asset policies may be a real-time control asset policy. At least two of the plurality of asset policies may be conditional policies that are active, each having a designated priority and the software sub-system processor is further operative to select one of the conditional policies based upon a preset criteria. The preset criteria can be a most aggressive energy saving mode. The software sub-system processor may be further operative to coordinate asset operation with co-located assets to improve efficiency. At least one of the plurality of asset policies may be a permission-based policy designed to improve safety. The server processor may be further operative to mark each of the asset policies as having a status of active or inactive and the software sub-system processor is further operative to precisely manipulate through an atomic request activation and deactivation of the plurality of asset polices based upon the status.

In another embodiment, the subject technology is directed to a system for facilitating a remote asset control system via a distributed computing network. The system includes a server in communication with a premise via the distributed computing network. The server includes a memory storing an instruction set and data related to a plurality of asset policies, and a processor for running the instruction set, the processor being in communication with the memory and the distributed computing network. The premise has at least one asset including: (i) a memory storing an instruction set and data related to a plurality of asset policies; and (ii) a processor for running the instruction set, the processor being in communication with the memory and the distributed computing network. The software sub-system processor is operative to: receive and store the plurality of asset policies from the server; autonomously control operation of the respective asset based upon the plurality of asset policies; and collect telemetry related to performance of the at least one asset.

The server processor may be further operative to poll the software sub-system and transfer the collected telemetry to the server. The server processor may be further operative to apply analytical algorithms to the collected telemetry to further optimize performance of the at least one asset. The server processor may be further operative to request asset deviance from asset policies.

Another embodiment of the subject technology is directed to a system for facilitating a remote asset control system via a distributed computing network including a server in communication with premises via the distributed computing network. The server includes a memory storing an instruction set and data related to a plurality of asset policies, and a processor for running the instruction set. The server processor is in communication with the memory and the distributed computing network, wherein the server processor is operative to create the plurality of asset policies using an asset policy inheritance scheme that generates composite asset policies based upon a hierarchical group structure. The system also has a plurality of the premises arranged in groups, each premise having at least one asset. Each asset includes a memory storing an instruction set and data related to a plurality of asset policies, and a processor for running the instruction set, the processor being in communication with the memory and the distributed computing network. The software sub-system processor is operative to receive and store the plurality of asset policies from the server, autonomously control operation of the respective asset based upon the plurality of asset policies, and collect telemetry related to performance of the at least one asset.

It should be appreciated that the subject technology can be implemented and utilized in numerous ways, including without limitation as a process, an apparatus, a system, a device, a method for applications now known and later developed or a computer readable medium. These and other unique features of the system disclosed herein will become more readily apparent from the following description and the accompanying drawings.

### BRIEF DESCRIPTION OF THE DRAWING

FIG. 1 is a schematic diagram illustrating an environment having a remote asset control system in accordance with the subject technology.

FIG. 2 is a schematic diagram illustrating a software application requesting policy creation, policy modification, or policy deletion from the remote asset control system of FIG. 1.

FIG. 3 is a schematic diagram illustrating policy inheritance and composite policy generation in the remote asset control system of FIG. 1.

FIG. 4 is a schematic diagram illustrating composite policy transference from the remote asset control system to a software sub-system co-located with an asset in accordance with the subject technology.

FIG. 5 is a schematic diagram illustrating a software sub-system conditionally enforcing a composite policy based on inputs thereby optimizing performance of a co-located asset in accordance with the subject technology.

FIG. 6 is a schematic diagram illustrating a software application controlling an asset with minimal latency by creating and modifying a real-time policy on the remote asset control system in accordance with the subject technology.

FIG. 7 is a schematic diagram illustrating atomic policy activation and deactivation within a policy-based asset control system in accordance with the subject technology.

FIG. 8 is a schematic diagram illustrating telemetry caching and transfer between an asset, a sub-system, a remote asset control system, and a software application in accordance with the subject technology.

### DETAILED DESCRIPTION OF THE INVENTION

The present disclosure overcomes many of the prior art problems associated with remotely controlling various assets such as devices that utilize power and other appliances. The advantages, and other features of the technology disclosed herein, will become more readily apparent to those having ordinary skill in the art from the following detailed description of certain preferred embodiments taken in conjunction with the drawings which set forth representative embodiments of the present invention and wherein like reference numerals identify similar structural elements.

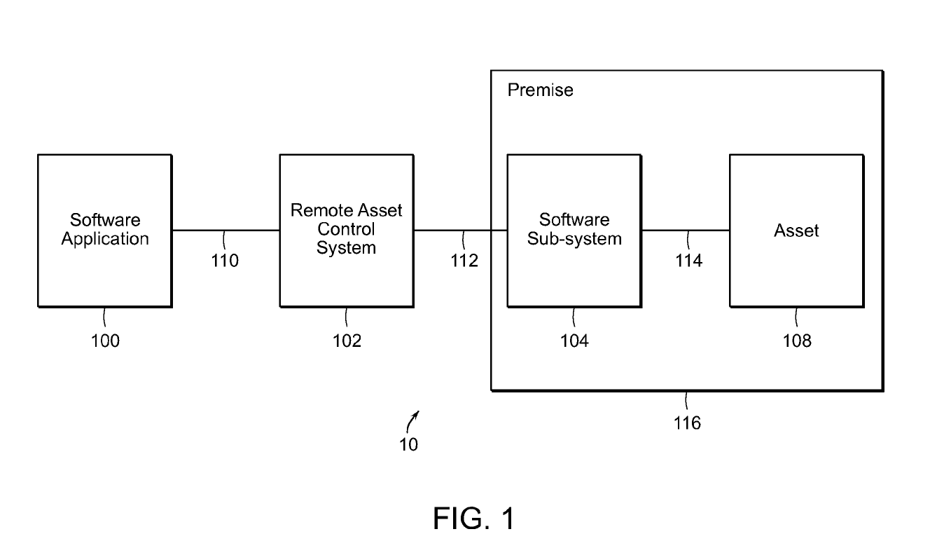

Referring now to FIG. 1, a schematic diagram illustrating an environment 10 for utilizing the subject remote asset control technology is shown.

The environment 10 includes a software application 100, a remote asset control system 102, communication network links 110, 112, 114, and a software sub-system 104 co-located with an asset 108 in a premise 116. The asset 108 is typically some type of appliance, meter or device that consumes or controls power consumption. The asset 108 may be in a residential, commercial, or industrial location. In brief overview, the remote asset control system 102 optimizes asset performance under a variety of circumstances such as network communication path failures.

For example, the asset 108 may be a thermostat, an electric, gas, or water meter, a solar panel, a hot water heater, a pool pump, a network router, a boiler, a lighting system, a computer, a television, a dishwasher, an un-interruptible power supply, a wind turbine and the like. To illustrate the subject technology, the following description is with respect to the asset 108 being a load controller or thermostat that controls an electrical load within the premise 116, which could be a residential, commercial, or industrial location. The asset 108 may be hosted on two microcontrollers where first microcontroller handles the network communications and the second microcontroller handles the asset application logic and where a round robin operating environment is used in both microcontrollers.

In the environment 10, the communication network links or paths 110, 112, 114 allow the software application 100, the remote asset control system 102, the software sub-system 104 and the asset 108 to be in communication. The communication network paths 110, 112, 114 are a combination of the Internet, a public or private local area network, a public or private wide area network, a public or private wireless area network, and the like. In a preferred embodiment, the software sub-system 104 creates a virtual private network over communication path 112 to the remote asset control system 102, which enables fully bi-directional Internet Protocol communications regardless of the presence of an Internet Protocol communications firewall restricting network traffic flow into and out of premise 116. As for communication path 114, a wireless area network is preferred.

The software application 100, the remote asset control system 102, and the software sub-system 104 are preferably hosted in one physical location but may be distributed at various geographic locations. The software application 100, the remote asset control system 102, and software sub-system 104, and the asset 108 will typically be implemented with a variety of programming languages such as Java or machine assembly language. In one embodiment, the software application 100, the remote asset control system 102, and software sub-system 104 are principally implemented in the Python language available from the Python Software Foundation in Wolfeboro Falls, N.H. A preferred embodiment of the asset 108 is implemented in C programming language.

The software sub-system 104 is managed like an asset using asset policies for the purposes of setting software versioning requirements, asset commissioning parameters, asset decommissioning, and asset replacement. The remote asset control system 102 sets asset policies specifically for the software sub-system 104. An asset policy is a rule or combination of rules that govern the operation of the respective asset. For example, if software sub-system 104 implements a ZigBee Smart Energy Profile 1.0 Trust Center as defined by the ZigBee Alliance in San Ramon, Calif. and the asset 108 is ZigBee Smart Energy Profile 1.0 compatible load controller, then the software application 100 would create an asset policy containing the hardware address and installation code of the asset 108 for the software sub-system 104 thereby allowing the asset 108 to securely operate with the software sub-system 104.

The premise 116 may be a single family dwelling unit, an apartment building, a campus comprised of multiple buildings, a high rise building, a residential multi-dwelling unit, or a commercial office space. The subject technology is particularly applicable to commercial buildings because commercial buildings have large energy and water loads to be managed, which better justifies the expense of installing new assets 108 that optimize usage.

The environment 10 will typically have a plurality of independent software applications that can communicate with the remote asset control system 102. Further, the environment 10 will typically have a plurality of assets 108 communicating to a plurality of software sub-systems 104 at a plurality of premises 116 communicating to a plurality of remote asset control systems 102. However, the following description is with respect to single components 100, 102, 104, 108 for simplicity. The environment 10 is instantiated such that the software application 100, the remote asset control system 102, and the software sub-system 104 are further sub-divided into separate hierarchical elements that create additional distinct layers of communication interactions.

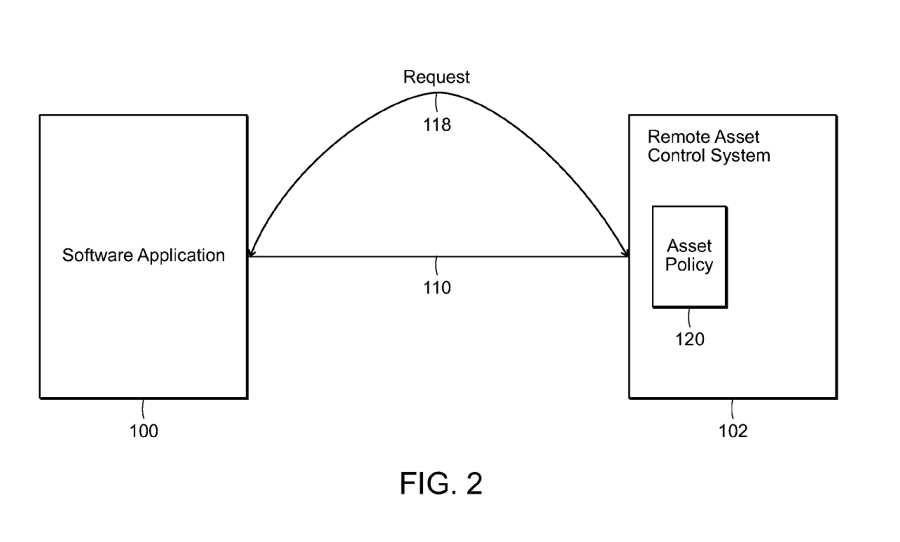

The environment 10 has policies described in more detail below (see items 120, 122, 124, 126, 128, 130, 140, 142, 151, 166, 168, 172, 174, 176, 178, 186 of FIGS. 2-8). Policies are stored in a relational database or file in memory of the remote asset control system 102 and the software sub-system 104. The software application 100 and the remote asset control system 102 transfer asset policies representations as an XML language encoding. The remote asset control system 102 and software sub-system 104 transfer asset policy representations as a Microsoft Windows-style INI encoding.

The asset policies define the expected behavior, settings, state, and other parameters of the thermostat asset 108 such as commissioning codes, thermostat heating and cooling set points, minimum firmware version of a load controller, on/off switch state, alarm temperature ranges, load controller duty cycle, electrical load shifting pattern, and electrical load balancing. The asset policies take into account various conditions such as time of day, the price of electricity, the relative stress level of the electrical grid, user preference, demand response event, business hours, and occupancy. The asset policies may represent the maximum variety of asset attributes under the maximum variety of conditions thereby enabling the software application 100 to best optimize asset performance under the maximum circumstances. An asset attribute is a characteristic of an asset that may be set by an asset policy. For example, a thermostat has a temperature setting, which is an attribute, and at various times the temperature setting varies according to the thermostat asset policy or policies.

Referring now to FIG. 2, a schematic diagram illustrating the software application 100 requesting policy creation, policy modification, or policy deletion from the remote asset control system 102 is shown. The software application 100 communicates a request 118 via communication path 110 to the remote asset control system 102 to create the asset policy 120. Example of requests 118 are a representational state transfer web service transaction, a SOAP web service transaction, an OpenADR transaction, a remote procedure call, a procedural call, and an object method invocation. The asset policy 120 will be marked as activated or deactivated as part of the request 118. The asset policy 120 is stored in the remote asset control system 102.

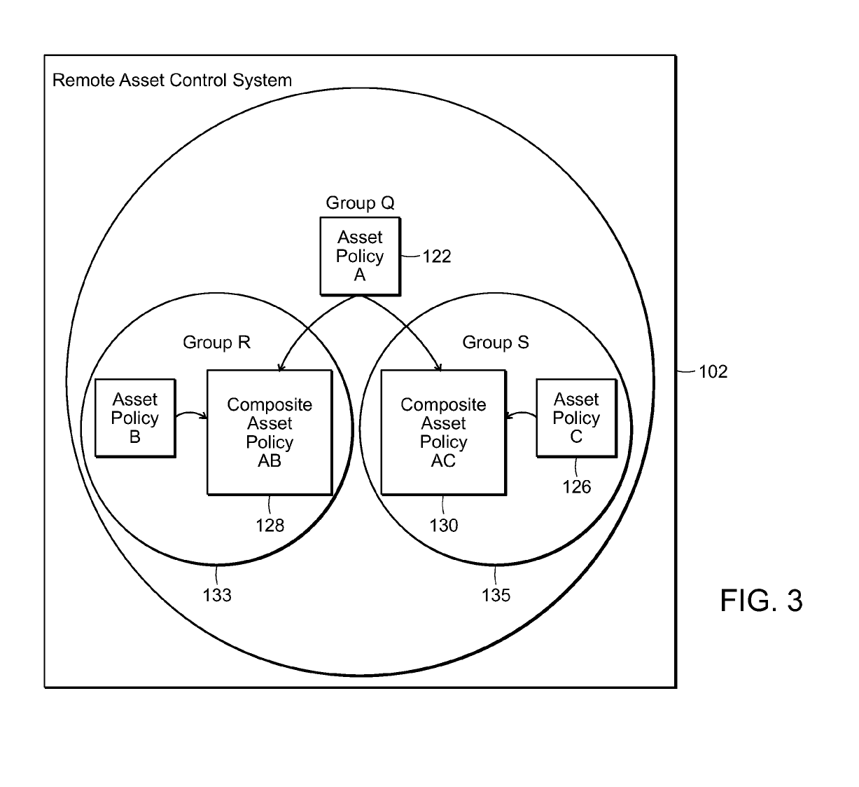

Referring now to FIG. 3, a schematic diagram illustrating policy inheritance and composite policy generation in the remote asset control system 102 is shown. The remote asset control system 102 includes groups 131, 133, 135. Groups 131, 133, 135 are logical asset encapsulation constructs, supporting hierarchical nesting, that enable assets of similar ilk to be managed in mass. For example, all of the thermostats for a national restaurant chain are assigned to a group and a single policy for that group would set the HVAC mode to Auto for all the thermostats. Group R 133 and group S 135 are hierarchically nested within group Q 131. The group hierarchy and location of the asset policies within the group hierarchy define the policy inheritance structure.

Composite policies 128, 130 are formed by merging higher level group hierarchy policies (e.g., asset policy 122) with policies (e.g., asset policies 124, 126) at the same hierarchy group level. As can be seen, both asset composite policies 128, 130 inherit asset policy A 122 since both group R 133 and group S 135 are sub-groups of group Q 131. Composite asset policy AB 128 additionally inherits 136 asset policy B 124. Likewise, composite asset policy AC 130 additionally inherits 138 asset policy C 126. The exact manner and rules of policy inheritance are consistent with inheritance mechanisms of object based languages such as Java.

For example, if asset policy A 122 defines a minimum thermostat firmware requirement of v1.1 and a thermostat occupied cooling set point of 76° F. and asset policy B 124 defines a thermostat unoccupied cooling set point of 82° F. and a thermostat occupied cooling set point of 79° F. then the composite asset policy AB 128 will define a policy with minimum thermostat firmware requirement of v1.1, unoccupied cooling set point of 82° F. and a thermostat occupied cooling set point of 79° F. In this case the policy element for the occupied cooling set point in asset policy A 122 is overridden by the overlapping policy element in asset policy B 124. Further, an arbitrary number of levels of the group hierarchy can contribute through inheritance to composite policies. The preferred embodiment of the present disclosure is for software application 100 to be able to create, modify, and delete arbitrary hierarchies of groups through a request using a representational state transfer web service transaction over an SSLv3 encrypted HTTP connection where the request is represented as an XML language encoding within the context of the request.

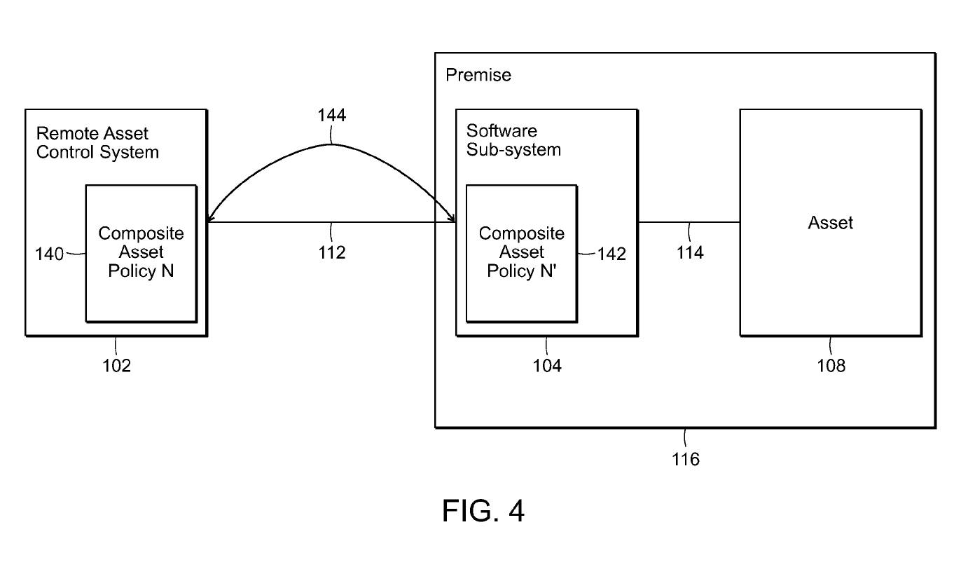

Referring now to FIG. 4, a schematic diagram illustrating composite policy transference from the remote asset control system 102 to the software sub-system 104 is shown. The remote asset control system 102 has composite asset policy N 140 and makes a request 144 to transfer a representation of the policy to the software sub-system 104 via network communication path 112. The software sub-system 104 stores composite asset policy N′ 142 which is a copy of composite asset policy N 140. The remote asset control system 102 will periodically re-attempt to make request 144 until such time that the remote asset control system 102 can confirm that the software sub-system 104 has a valid copy of the policy N 140 or the software sub-system 104 will periodically query the remote asset control system 102 for composite asset policy N 140.

The ability of the remote asset control system 102 and software sub-system 104 to complete the request to copy the policy N 140 is unaffected by the current ability of the software sub-system 104 to communicate via communication path 114 to the asset 108. If the remote asset control system 102 is unable to copy the policy N 140, then the remote asset control system 102 would reattempt to copy the policy N 140 again, for example every 2 minutes, until the copy was successful. The remote asset control system 102 and the software sub-system 104 maintain a plurality of composite asset policies pertaining to a plurality of assets.

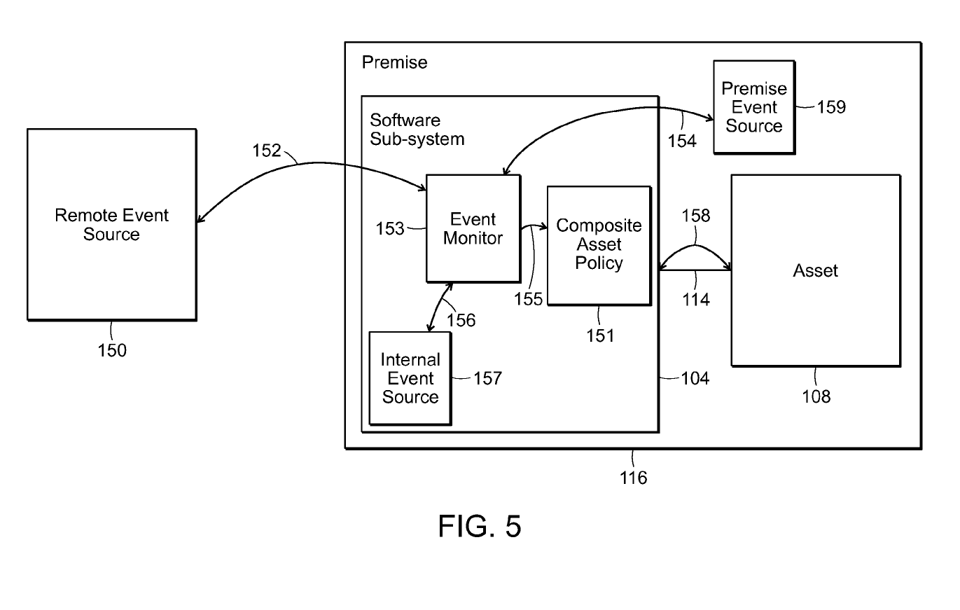

Referring now to FIG. 5, a schematic diagram illustrating the software sub-system 104 conditionally enforcing a previously copied composite policy 151 is shown. The composite policy 151 is based on inputs from an event monitor 153 thereby optimizing performance of the co-located asset 108. The event monitor 153 is able to detect state changes from an internal event source 157 via internal communication path 156, a premise event source 159 via premise communication path 154, and a remote event source 150 via remote communication path 152.

Event sources 150, 157, 159 generate inputs such as date and time based schedules, utility issued demand response events, utility signaled cost of electricity, and the operational status of a premise asset. The inputs are signaled asynchronously to the event monitor 153 or are polled periodically by the event monitor 153. The internal event source 157 is typically a thread within the software sub-system's application process space, but may also be instantiated as an interrupt handler, process, function call, object, or state machine.

The premise event source 159 is typically another premise asset, such as another thermostat. The remote event source 150 is typically an Internet accessible server for signaling events and conditions generated by external sources which may alter the desired optimal operation of the assets. For example, an electric utility's public OpenADR server is publishing the real-time price of electricity which invokes a conditional policy on the software sub-system 104 causing a dishwasher to delay running when the price is above $0.20/kWh.

Inputs from the sources 150, 157, 159 are passed from the event monitor to the composite asset policy 151 along path 155. These inputs determine which conditional elements of the composite asset policy 151 are enforced on the asset 108 by the software sub-system 104 making requests 158 via network communication path 114 to the asset 108. For example, if composite asset policy 151 has a first conditional policy element that indicates that the thermostat occupied cooling set point is 75° F. during the hours of 9 am to 4:59 pm and a second conditional policy element that indicates that the thermostat occupied cooling set point is 82° F. during the hours of 5 pm to 8:59 am, then during the hours of 9 am to 4:59 pm, the software sub-system 104 will enforce the first conditional policy element and the occupied cooling set point is set to 75° F.

The internal event source 157 would periodically monitor time and send an event to the event monitor 153 when the current time changed to 5 pm. The event monitor 153 will then select the second conditional policy element and send request 158 to change the thermostat occupied cooling set point to 82° F., which is maintained until 9 am the following morning.

A composite asset policy will typically contain a plurality of conditional policy elements having a plurality of distinct event conditions that cause the conditional policy element to be enforced by the software sub-system 104. The event monitor 153 may determine that multiple conditional elements of the composite asset policy 151 are active. As such conflicts between conditional policy elements may arise. During the creation of a policy on the remote asset control system 102, the software application 100 will indicate a relative priority of the potentially conflicting conditional policy elements using a numbering system where 1 is a lowest priority and larger integer numbers indicate higher priority. Relative priority may also be identified by the type of policy element or the policy elements inheritance hierarchy.

The software sub-system 104 will resolve conflicting conditional policy elements by choosing the one with the highest relative priority. In the case that more than one conditional policy element are active and two ore more conditional policy elements are tied at the highest relative priority, then the software sub-system can break the tie by choosing the conditional policy element with the most aggressive energy saving mode, through random selection, by first conditional element within the composite asset policy, by the most conservative mode of operation, or combinations thereof depending on the type of asset.

Still referring to FIG. 5, the asset 108 may have limited ability to store configuration data that allows the asset to function with limited autonomous operation when the communication network path 114 to the software sub-system 104 has failed. For example, if the asset 108 is a thermostat with the ability to configure an occupied cooling set point schedule, then the software sub-system 104 would be able to configure the thermostat schedule based on composite asset policy 151. As a result, the thermostat occupied cooling set point is 75° F. during the hours of 9 am to 4:59 pm and the thermostat occupied cooling set point is 82° F. during the hours of 5 pm to 8:59 am. The thermostat asset 108 would be able to change the occupied cooling set point based on time independent of the ability of the software sub-system 104 to communicate to the asset via communication path 114. The thermostat asset 108 would have an internal clock, which is typically synchronized with the software sub-system 104. The thermostat asset 108 can not only automate simplistic time based schedules but also coordinate its operation with other co-located thermostats. For example, the thermostat asset 108 can reduce peak load by alternating the cooling of different zones in a non overlapping manner.

Still referring to FIG. 5, the asset 108 may be a large electrical load such as an electric vehicle charging station, manufacturing equipment, warehouse lighting, or air conditioning units. The composite asset policy 151 permits the asset 108 to draw a maximum load for short periods of time. The asset 108 can exceed the time limit if the software sub-system's 104 event monitor 153 receives an event from one of the event sources 150, 157, 159 indicating that the asset 108 has permission to continue drawing a maximum load for an additional period of time. If an event granting permission is not received, then the software sub-system 104 causes the asset 108 to reduce consumption. The consumption reduction is preferably 25% of the maximum load, but may be as little as 0% and as much as 99% depending upon the asset 108.

The asset 108 may consume electricity, gas, or water such as a gas-fired furnace and lawn sprinkler system. For example, electric utilities undersize pole transformers that convert medium voltages from transmission lines to those voltages appropriate for residential and small commercial buildings. In the past these undersized transformers normally, and safely, exceeded ideal internal temperatures towards the end of the day and at night. Due to significantly reduced demand, the transformers had time to cool down to normal operating temperatures. With the adoption rate of plug-in electric vehicles accelerating, increased over night charge may become a significant load during the night. Utilities are now concerned that the nightly cooling off period for these transformers will not happen or that the transformers may be overloaded.

Operating outside the ideal temperature range for extended periods of time or being overloaded will cause the transformers to fail prematurely and cause localized blackouts. A typical level 2 car charger can consume a significant amount of electricity. The expected clustering of electric vehicles in some neighborhoods makes it more likely that there may multiple electric vehicles serviced by the same transformer. To combat this problem, the utility can offer an electric vehicle charging kit to consumers. The consumers are offered a substantially discounted rate for charging their vehicles if they allow the utility to reduce or stop charging the electric vehicle when the utility determines that the transformer is not in its ideal temperature range or is near overloaded.

The kit includes an in-home energy management system that connects to the user's broadband Internet connection and also connects to a level 2 charging station via a ZigBee Smart Energy 1.0 compliant communication interface. A policy is set by the utility software systems on the remote asset control system 102. Through the policy inheritance mechanism, a composite policy is created and transferred to the premise energy management systems deployed at several thousand homes within the utility's service territory. For example, the composite policy can allow charging up to 100% for up to 5 minutes with permission and up to 25% without permission.

The energy management system connects, via the Internet or utility backhaul, to a utility substation computer to determine if the co-located charging station is permitted to charge at up to 100%. The utility substation computer is able to monitor the transformer associated with the charging station, and determine if the temperature is within the desired range. When the transformer may be near overload, the utility substation computer can either grant or deny charging permission back to the energy management system.

At one specific customer location, the premise energy management system is granted permission by the utility sub-station computer to allow the charging station to go up to 100% usage for the next 5 minutes. The energy management system at a second customer location, also supplied by the same transformer, contacts the substation computer to check for permission to charge. The substation computer determines that the transformer's temperature is acceptable because the transformer is not near overload. The substation grants permission to the second customer location to charge at 100% for the next 5 minutes.

After a few minutes, the first energy management system contacts the utility substation computer requesting permission to charge at 100%. The utility substation computer determines that the transformer is outside the acceptable temperature range and denies permission to charge at up to 100%. The first energy management system sets the charging station to a 25% duty cycle. The first energy management system will request permission to charge at 100% again in a few minutes. Because of the reduced charging, the transformer's temperature is maintained in the normal range. Permission-based policies also help keep the transformer safe in the case that the Internet connection is down since all the charging stations will be reduced to 25% charging rate. The utility may also have the substation computer indicate a specific charge rate for the next period to the energy management system.

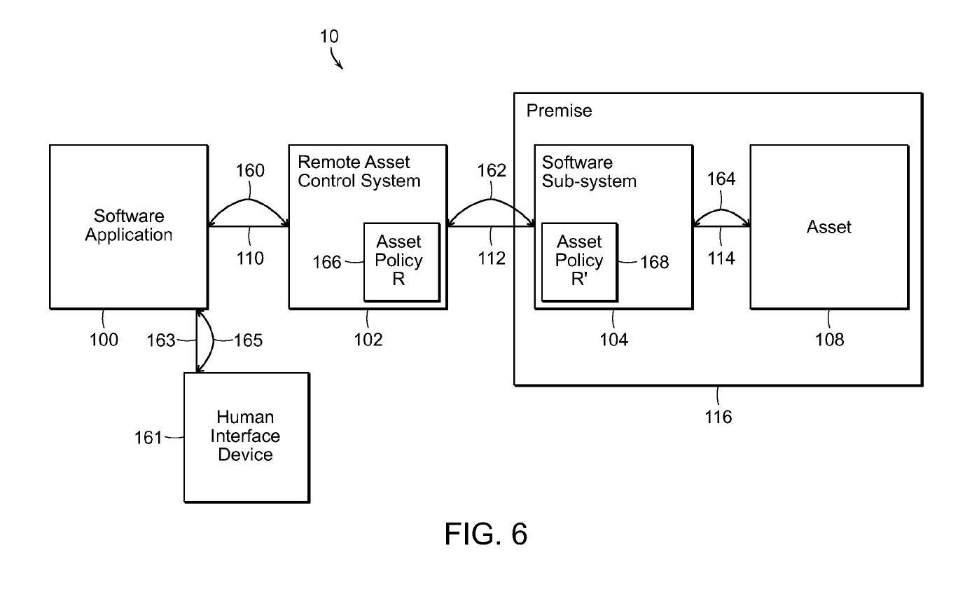

Referring now to FIG. 6, a schematic diagram illustrating a software application 100 controlling an asset 108 with minimal latency by creating and modifying a real-time policy 166 on the remote asset control system 102 is shown. The system 10 has a human interface device 161 that permits require real-time control of the asset 108. The human interface device 161 is typically actively controlled by a human user, but may also be running a software agent acting on behalf of the human user based upon pre-configured preferences. Real-time control typically means that the latency of control commands requested by the human interface device 161 until acted upon by the asset 108 is less than 1 second, but may be as much as 10 seconds or more. In one embodiment, the human interface device 161 is a mobile cellular smart phone, a computer, a personal data assistant, a land line telephone, a television, or a wireless remote control.

The sequence of events that enables the human interface device 161 to control the asset 108 in real-time is typically initiated by the human interface device 161 via communication path 163. The human interface device 161 makes a request 165 to the software application 100 to create a real-time asset policy R 166 on remote asset control system 102. The software application passes along a request 160 via communication path 110.

On the real-time asset policy R 166 is on the remote asset control system 102, the remote asset control system 102 copies the asset policy R 166 to the software sub-system 104 via communication path 112 with request 162 creating real-time asset policy R′ 168. The software sub-system 104 now enforces real-time asset policy R′ 168 on asset 108 through request 164 on network communication path 114. Communication paths 163, 110, 112, 114 and request channels 165, 160, 162, 164 are typically kept in a ready state for the purpose of minimizing the latency for subsequent control commands from the human interface device 161 to be acted upon by the asset 108.

The human interface device 161 typically communicates to the software application 100, but may also directly communicate to the remote asset control system 102 or the software sub-system 104 to further minimize the latency of control commands. The software application 100 may also request real-time control of the asset 108 as if the software application 100 itself were acting as a human interface device 161. Request channels 165, 160, 162, are preferably a representational state transfer web service, but may also be a SOAP web service, an OpenADR server, remote procedure call, procedural call, object method invocation, and the like, and where request channel 164 is preferably ZigBee Smart Energy Profile 1.0, but may also typically be Modbus, HomePlug AV, BACnet, RS-232, RS-485, and the like.

In one embodiment, the software application 100 presents a virtual thermostat control on the screen of a smart phone. The user expects that their control changes take effect in real-time on the actual physical thermostat asset 108. The smart phone would indicate to the software application 100 that real-time control of the thermostat is desired. The software application 100 creates the real-time asset policy R 166 on the asset control the environment 102 which efficiently creates real-time asset policy R′ 168 on software sub-system 104 which in turn controls the asset 108 via network communication link 114. When subsequent control commands are requested by the human interface device 161, subsequent control commands are efficiently propagated to the thermostat asset 108 such that changes occur with minimal latency. A benefit of using a real-time asset policy as described is that other policies which may be in effect are automatically suppressed, which eliminates potential contention between the control commands that the human interface device is requesting and what would normally be the currently enforced policy.

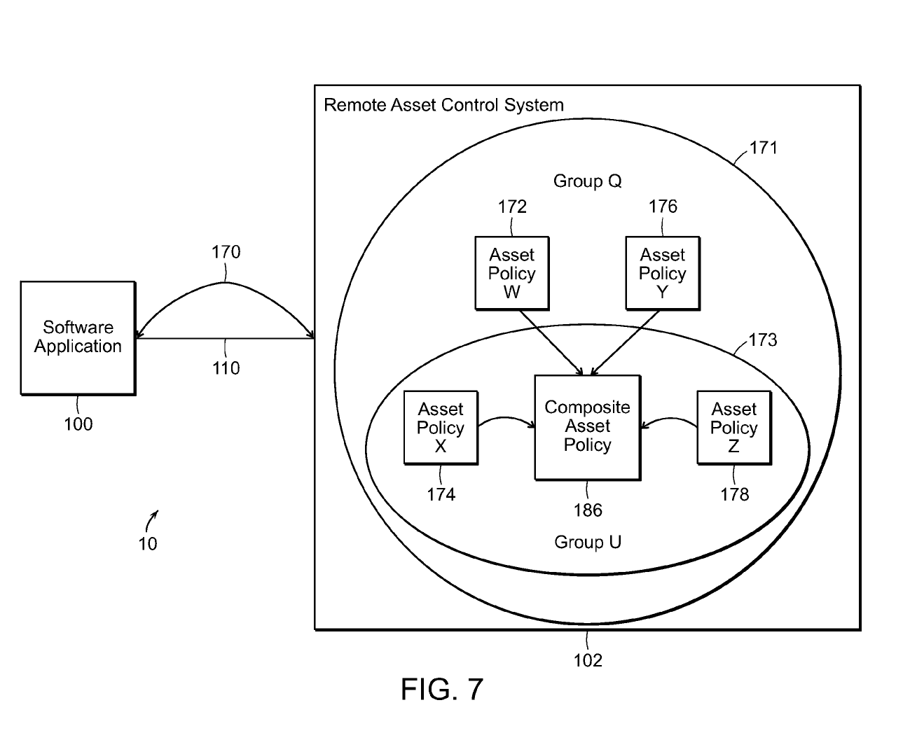

Referring now to FIG. 7, a schematic diagram illustrating atomic policy activation and deactivation within a policy-based asset control system 102 is shown. The hierarchical grouping and inheritance scheme described in FIG. 7 is consistent with those described for FIG. 3. The exemplary environment 10 has asset policies 172, 174, 176, 178 and a composite asset policy 186. The asset policies 172, 174 are initially active and asset policies 176, 178 are initially inactive. The environment 10 also includes asset group Q 171, which hierarchically contains group U 173. Asset policies 172, 176 belong to group Q 171 and asset policies 174, 178 belong to group U 173.

Initially, the composite asset policy 186 inherits asset policy W 172 and asset policy X 174, but does not initially inherit policies Y, Z 176, 178 because policies Y, Z 176, 178 are currently marked as inactive. Then, the software application 100 sends a request 170 via network communication path 110 to the remote asset control system 102 to mark the asset policies 172, 174 inactive. The asset policies 176, 178 are also marked active, and composite asset policy 186 is atomically updated. The composite asset policy 186 does not enter a partially complete, incorrect, or corrupted state. The result is a business logic thread that enables an atomic transaction that activates or deactivates a plurality of policies affecting, via inheritance, a composite asset policy to lock the relational database in which the policies are stored until all the updates are completed. Such locking prevents other threads from reading the composite asset policy prematurely, but may also use file locks, semaphores, mutexes, critical sections, work queues, and the like to ensure the atomic nature of the transaction.

When creating policies on the remote asset control system 102, the software application 100 simultaneously marks the policies as active or inactive. The ability of the software application 100 to precisely manipulate, through an atomic request 170, the activation and deactivation of a plurality of polices 172, 174, 186, 178 within a hierarchy of policy inheritance maintains the integrity of the composite asset policy 186 at all times.

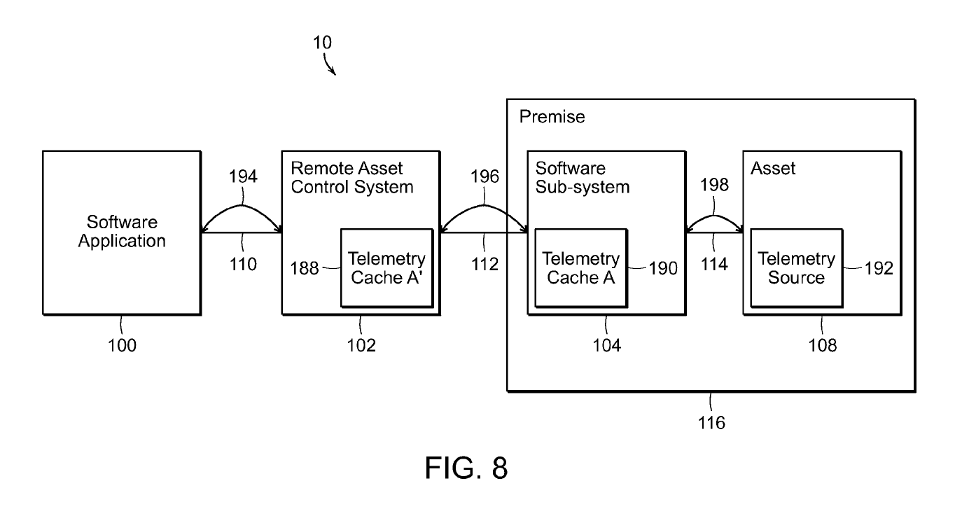

Referring now to FIG. 8, a schematic diagram illustrating telemetry caching and transfer between an asset 108, a software sub-system 104, a remote asset control system 102, and a software application 100 is shown. The environment 10 has a telemetry source 192 on asset 108, telemetry cache A 190 on software sub-system 104, and telemetry cache A′ 188 on remote asset control system 102. The software application 100 can request 194, via network communication path 110, present and historical telemetry regarding asset 108 from remote asset control system 102.

The software sub-system 104 provides requests 198 to read from the telemetry source 192. The requests 198 and other information are stored in telemetry cache A 190. The preferred embodiment is for software sub-system to periodically poll, but data may also be asynchronously sent from the asset 108. The telemetry of the polling cycles is stored within the telemetry cache A 190 to include a timestamp of when the telemetry was read and including a reference, pointer, name, and the like to the composite asset policy, conditions, and conditional policy elements being enforced at the time the telemetry was polled.

The software sub-system 104 stores the telemetry from a plurality of polling cycles in a manner that the data can be retrieved by the remote asset control system 102. Further, the software sub-system 104 can poll for asset telemetry regardless of the current ability of the remote asset control system 102 to make requests 196 via network communication path 112 to the software sub-system 104 and regardless of the current ability of the software application 100 to make requests 194 to the remote asset the environment 102 via network communication path 110. For example, even if the network communication path 112 is not working since the Internet Service Provider is performing network maintenance, the software sub-system 104 can continue to poll the asset 108 for telemetry and store it in telemetry cache A 190.

Still referring still to FIG. 8, the remote asset control system 102 is able to copy 196 telemetry cache A 190 from software sub-system 104 and create telemetry cache A′ 188. Preferably, the remote asset control system 102 periodically polls the software sub-system 104 for data in the telemetry cache A 190 using Secure FTP. The telemetry of each polling cycle is stored within the telemetry cache A′ 188 as a relational database along with metadata including a timestamp of when the telemetry was copied from the software sub-system 104.

The software sub-system 104 asynchronously transfers the telemetry cache A 190 to the remote asset control system 102. The remote asset control system 102 polls for and copies telemetry cache A 190 regardless of the current ability of the software sub-system 104 to communicate with asset 108 via network communication path 114 and regardless of the current ability of the software application 100 to communicate to the remote asset control system 102 via network communication path 110. For example, if the software application 100 is being updated to a new software release, during which time it is unable to communicate with the remote asset control system 102, the remote asset control system 102 continues to poll the software sub-system 104 for telemetry cache A 190 and update telemetry cache A′ 188.

Still referring to FIG. 8, the software application 100 provides a request 194 for both current telemetry and historical telemetry from telemetry cache A′ 188 residing on the remote asset control system 102. The software application makes a representational state transfer web service request with a query option indicating if the request is for the most recent telemetry or historical telemetry from telemetry cache A′ 190. Further, the software application 100 may request 194 telemetry from the remote asset control system 102, regardless of the current ability of the remote asset control system 102 to communicate with and retrieve telemetry from the software sub-system 104 via network communication path 112 and regardless of the current ability of the software sub-system 104 to communicate and retrieve telemetry from asset 108 via network communication path 114. For example, if the software sub-system 104 is undergoing temporary system maintenance precluding communication with the remote asset control system 102 via network communication path 112, the software application 100 is able to request telemetry from the remote asset control system 102 via network communication path 110.

The caching of asset 108 telemetry by the software sub-system 104 eliminates a plurality of potential interruptions that may cause gaps in the recorded telemetry. Further, the secondary telemetry cache in the remote asset control system 102 maximizes the ability of the software application 100 to read telemetry. The result is minimal gaps in the recorded telemetry. By having thorough and accurate data, the telemetry is useful in analytical algorithms by the software application 100 to further optimize the performance of the asset 108 or plurality of assets 108 and the performance of the environment 10 generally.

Referring again to FIG. 7, the software application 100 queries the remote asset control system 102 to only return telemetry concerning the asset 108 that is in violation of the composite asset policy currently enforced by software sub-system 104. Thus, the software application 100 efficiently detects anomalies that may cause sub-optimal asset performance. For example, the AC relay of a load controller asset connected to an electric hot water heater is faulty and always latched in the “on” position. The software application 100 has created a policy for the load controller to turn off during a utility demand response event scheduled at 2 pm. At 2 pm, the software sub-system 104 commands the load controller to turn off, but due to the faulty AC relay, the load controller does not. The software application 100 is able to send an efficient request to the remote asset control system 102 returning only a listing of assets not performing as expected based upon enforced policy, e.g., the load controller would be reported as being in the “on” state when the load controller should have been in the “off” state.

When the number of assets being managed by the remote asset control system 102 is large, the method of requesting asset deviance from policy ensures that the software application 100 can more rapidly address the problem. For example, a repair crew is more quickly deployed to replace a faulty load controller, or additional load controller assets are turned off to compensate for the load reduction not achieved by the faulty load controller. Typically, the software application 100 sends a request to the remote asset control system 102 operating on a plurality of assets that are part of the same hierarchical group. Then, the remote asset control system 102 returns a list of assets not performing as expected based upon the current enforced policy.

One advantage of the subject technology is substantially optimized asset performance compared to conventional asset control systems because the co-located software sub-system continuously controls the assets by conditionally enforcing policy based upon a combination of remote, co-located, or internal inputs. The software application may set a permission-based policy that helps to ensure that assets reduce their consumption to a safe level when not explicitly permitted to use its highest consumption modes. This permission-based policy can help to make the electrical grid more reliable since the asset's default operational state is to operate in a mode that can typically be supported by a utility in less than ideal circumstances.

The software application also performs as if the software application were a conventional asset control system when the environment requires real-time asset control. Further, the software application of the subject technology has substantially fewer asset telemetry gaps compared to conventional remote asset control systems since the asset telemetry at multiple levels is cached and allows historical queries. The reduced asset telemetry gaps enable better analysis of asset performance which may be used in feedback to look for changes to policy for the asset to further optimize asset performance.

Further, a software application making a single policy change request to the present disclosure can change the control of a plurality of assets by virtue of policy inheritance, whereas a different software application would be required to make a plurality of individual requests to a conventional remote asset control system to achieve the same result. The advantage of the hierarchal policy organization of the present disclosure is to enhance the ability of the software application to consistently control assets of similar ilk. Further, the ability of the subject technology to allow a software application to atomically activate and deactivate policies ensures that corrupted, incomplete, or incorrect composite policies are never propagated to software sub-systems that could result in incorrect or sub-optimal asset performance.

Further, the subject technology allows software applications the advantage of setting policies regardless of the current ability of the policy-based asset control system to communicate to the software sub-system or the current ability of the software sub-system to communicate with the asset. Compared to conventional remote asset control systems, the software application does not need to track and continually retry requesting control commands until an asset becomes accessible and is able to process such a control request via a plurality of communication network paths.

For example, an electric utility wants to shave peak loads during times of high demand. The electric utility creates a demand response program for small commercial customers that gives electricity discounts to those who participate. Once enrolled, the electric utility replaces the customer's existing thermostats, installs a 30 A load controller on the electric hot water heater, and installs a premise energy management system. The electric utility installs similar systems of thermostats, load controllers, and premise energy management systems at the premises of several thousand customers in their service territory.

The utility's enterprise software, acting as a software application 100, provides a web portal for their customers to create thermostat set point schedules helping to optimize daily energy efficiency. The electric utility also provides a mobile cellular smart phone application allowing real-time thermostat control to enable managers to remotely override the normal thermostat set point schedule. The utility's enterprise software translates the customer's daily thermostat set point preferences into policies on the remote asset control system 102 as described above. The remote asset control system 102 generates composite asset policies that are transferred to the premise energy management systems, a typical form of a software sub-system 104.

The premise energy management system is able to autonomously manage the customer's thermostat set point daily schedules regardless of the ability of the utility enterprise software or the remote asset control system 102 to communicate to either the premise energy management system or the thermostat. Further, when a manager of a specific premise attempts to control the set points of a thermostat in real-time via the utility provided thermostat application on his mobile cellular smart phone, the utility enterprise software creates a real-time policy which minimizes the latency of control actions commanded from the manager's phone, while simultaneously and transparently overriding the daily thermostat set point schedule as desired.

Continuing with the electric utility application example, the electric utility forecasts that record high temperatures will cause electric demand to exceed electric supply. The electric utility issues a demand response event to the small commercial customers that are participating in the demand response program. The electric utility's enterprise software, nearly 24 hours in advance of the anticipated demand response, event creates a new group asset policy on the remote asset control system, that will be inherited by the individual policies of all the thermostat and load controller assets located at participating customer premises.

The new group asset policy will set back thermostats an additional 3° F. and turn off loads connected to the load controllers for 4 hours starting at 3 pm with a 15 minute start and end randomization. The remote asset control system 102 copies the atomically updated composite asset policy to each of the energy management systems at the customer's premise. The energy management systems operate normally and continue to manage the customer's thermostat set points according to the customer's preferred setting.

Then at 3 pm, plus up to an additional 15 minutes of randomization, the energy management system, at each premise, enforces the additional 3° F. thermostat set point offset and turns off the loads attached to the load controllers even though the connecting Internet service provider is down for many of the commercial customers participating in the utility demand response program. At the conclusion of the utility demand response event at 7 pm, plus an additional 15 minutes of randomization, the energy management system at each customer premise returns the thermostat set point back to the customer desired setting for their daily schedule and turn the loads attached to the load controllers back on.

If during the event, the customer opted out of the specific utility demand response event, the opt out was recorded by the premise energy management system. Later, if the Internet service provider has been able to restore service to its customers, the remote asset control system 102 is able to retrieve all of the historical telemetry gathered at periodic intervals. A typical interval would be 1 minute. The historical telemetry is cached by the energy management system for both the thermostat and load controller including timestamps and references to the composite asset policy, conditions, and conditional policy elements active for each telemetry reading.

The remote asset control system 102 retrieves the telemetry from all of the energy management systems for all the customers participating in the utility demand response program, enables the utility enterprise software to query for asset deviance from the load control event policy, and then quickly detects any customers that opted out of the utility load control event as well as any faults such as a load controller with a disabled AC relay. By recognizing the disabled load controller, the remote asset control system can automatically generate a utility service work ticket.

The next day while processing the work ticket, a technician identifies a new replacement load controller via a web interface of the software application. The technician specifies the new load controller, via its hardware address, as an alternate asset and schedules an electrician to make a service call. When the electrician replaces the faulty load controller with the new one, the new load controller is immediately managed according to the same polices as the original asset making the new load controller less likely to be managed incorrectly for future demand response events.

Still further, the utility enterprise software also reads all of the telemetry for all of the thermostats and load controllers so that a batch analysis normally taking 6 hours can begin. Because of the detailed telemetry gathered by the energy management systems, the batch analysis of the telemetry collected from the thermostats and load controllers indicates that a 10 minute start and end randomization is sufficient to allow the electrical grid to cope with the demand response event. Thus, the electric utility is able to further optimize the performance of the thermostat and load controller assets by reducing the start and end randomization time.

It will be appreciated by those of ordinary skill in the pertinent art that the functions of several elements may, in alternative embodiments, be carried out by fewer elements, or a single element. Similarly, in some embodiments, any functional element may perform fewer, or different, operations than those described with respect to the illustrated embodiments. Also, functional elements (e.g., modules, databases, interfaces, computers, servers, communication devices, and the like) shown as distinct for purposes of illustration may be incorporated within other functional elements in any particular implementation.

While the invention has been described with respect to preferred embodiments, those skilled in the art will readily appreciate that various changes and/or modifications can be made to the invention without departing from the spirit or scope of the invention. For example, each claim may depend from any or all claims, even in a multiple dependent manner, even though such has not been originally claimed.

What is claimed is:

1. A system for facilitating a remote asset control system via a distributed computing network comprising:
(a) a server in communication with premises via the distributed computing network, the server including: (i) a memory storing an instruction set and data related to a plurality of asset policies; and (ii) a server processor for running the instruction set, the processor being in communication with the memory and the distributed computing network, wherein the server processor is operative to create the plurality of asset policies using an asset policy inheritance scheme that generates composite asset policies based upon a hierarchical group structure to atomically activate and deactivate asset policies, which are part of the policy inheritance hierarchy, ensuring composite policy integrity;
(b) a plurality of the premises, each premise having at least one software sub-system, each software sub-system including: (i) a memory storing an instruction set and data related to a plurality of asset policies; and (ii) a software sub-system processor for running the instruction set, the processor being in communication with the memory and the distributed computing network, wherein the software sub-system processor is operative to: (A) receive and store the plurality of asset policies from the server; and (B) control operation of the respective asset based upon the plurality of asset policies.

2. The system according to claim 1, wherein at least one of the plurality of asset policies is a permission-based asset policy for throttling consumption by the respective asset.

3. The system according to claim 1, wherein at least one of the plurality of asset policies is a real-time control asset policy.

4. The system according to claim 1, wherein at least two of the plurality of asset policies are conditional policies that are active, each having a designated priority and the asset processor is further operative to select one of the conditional policies based upon a preset criteria.

5. The system according to claim 5, wherein the preset criteria is a most aggressive energy saving mode.

6. The system according to claim 1, wherein the software sub-system processor is further operative to coordinate asset operation with co-located assets to improve efficiency.

7. The system according to claim 1, wherein at least one of the plurality of asset policies is a permission-based policy designed to improve safety.

8. The system according to claim 1, wherein the server processor is further operative to mark each of the asset policies as having a status of active or inactive and the asset processor is further operative to precisely manipulate through an atomic request activation and deactivation of the plurality of asset polices based upon the status.

9. A system for facilitating a remote asset control system via a distributed computing network comprising:
(a) a server in communication with a premise via the distributed computing network, the server including:
(i) a memory storing an instruction set and data related to a plurality of asset policies; and
(ii) a server processor for running the instruction set, the processor being in communication with the memory and the distributed computing network;
(b) the premise having at least one software sub-system including:
(i) a memory storing an instruction set and data related to a plurality of asset policies; and
(ii) an software sub-system processor for running the instruction set, the processor being in communication with the memory and the distributed computing network, wherein the asset processor is operative to:
(A) receive and store the plurality of asset policies from the server;
(B) autonomously control operation of the respective asset based upon the plurality of asset policies; and
(C) collect telemetry related to performance of at least one asset.

10. The system according to claim 10, wherein the server processor is further operative to poll the software sub-system for a communication path and transfer the collected telemetry to the server.

11. The system according to claim 11, wherein the server processor is further operative to apply analytical algorithms to the collected telemetry to further optimize performance of at least one asset.

12. The system according to claim 10, wherein the asset processor is further operative to request asset deviance from asset policies.

13. A system for facilitating a remote asset control system via a distributed computing network comprising:
(a) a server in communication with premises via the distributed computing network, the server including:
(i) a memory storing an instruction set and data related to a plurality of asset policies; and
(ii) a processor for running the instruction set, the processor being in communication with the memory and the distributed computing network, wherein the processor is operative to create the plurality of asset policies using an asset policy inheritance scheme that generates composite asset policies based upon a hierarchical group structure;
(b) a plurality of premises, each premise having at least one software sub-system, each software sub-system including:
(i) a memory storing an instruction set and data related to a plurality of asset policies; and
(ii) a software sub-system processor for running the instruction set, the processor being in communication with the memory and the distributed computing network, wherein the software sub-system processor is operative to:
(A) receive and store the plurality of asset policies from the server;
(B) autonomously control operation of an asset, associated with the software sub-system processor, based upon the plurality of asset policies; and
(C) collect telemetry related to performance of the respective asset.

14. The system according to claim 13, wherein the server processor is further operative to define groups of the assets that enables the assets of a similar type to be similarly managed.

15. The system according to claim 14, wherein a first group includes a plurality of thermostats in different locations.

16. The system according to claim 15, wherein a second group is hierarchically nested within the first group.

17. The system according to claim 13, wherein the asset policies include a conditional asset policy that alters operation of the respective asset when a certain condition is met.

18. The system according to claim 17, the certain condition arises from a location external to the respective asset.

19. The system according to claim 18, wherein the respective asset consumes electricity and the certain condition is a price of electricity.

20. The system according to claim 19, wherein the conditional policy causes an operational delay of the respective asset.
